(19) United States
(12) Patent Application Publication
(10) Pub. No.: US 2012/0308070 A1
(43) Pub. Date: Dec. 6, 2012

(54) SLIM TYPE SPEAKER AND MAGNETIC CIRCUIT THEREFOR

(75) Inventors: Han Ryang LEE, Gyeonggi-do (KR); Kyu Dong KIM, Incheon (KR)

(73) Assignee: BSE CO., LTD., Incheon (KR)

(21) Appl. No.: 13/458,392

(22) Filed: Apr. 27, 2012

(30) Foreign Application Priority Data
Apr. 28, 2011 (KR) 10-2011-0039963

(51) Int. Cl. H04R 1/00

(52) U.S. Cl. 381/412

(57) ABSTRACT

A magnetic circuit and a speaker including the magnetic circuit. The speaker includes: a bottom case; a magnetic circuit including a perpendicular-magnetized permanent magnet and a horizontal-magnetized permanent magnet spaced apart from each other by a predetermined interval; a diaphragm; a voice coil attached on a surface of the diaphragm, disposed in a magnetic gap between the perpendicular-magnetized permanent magnet and the horizontal-magnetized permanent magnet and which vibrates the diaphragm; and a front cover coupled to the bottom case to fix the magnetic circuit and the diaphragm. The magnetic circuit includes a perpendicular-magnetized permanent magnet and a plurality of horizontal-magnetized permanent magnets. The perpendicular-magnetized permanent magnet is disposed between the plurality of horizontal-magnetized permanent magnets such that the plurality of horizontal-magnetized permanent magnets support the diaphragm and interact with the perpendicular-magnetized permanent magnet to create a uniform magnetic field.

### CROSS-REFERENCE TO RELATED PATENT APPLICATION

This application claims the benefit of Korean Patent Application No. 10-2011-0039963, filed on Apr. 28, 2011, in the Korean Intellectual Property Office, the disclosure of which is incorporated herein in its entirety by reference.

### BACKGROUND OF THE INVENTION

1. Field of the Invention

The present invention relates to a speaker and a magnetic circuit therefor, and more particularly, to a magnetic circuit for further thinning a speaker and a slim type speaker including the magnetic circuit.

2. Description of the Related Art

A speaker is a device for converting an electrical signal into a voice signal. Speakers may be classified into middle and large-sized speakers and small-sized speakers. A middle and large-sized speaker is connected to a stereo or amplifier so as to amplify a sound. A small-sized speaker is used in small-sized portable devices, such as cellular phones, notebook computers, MP3 players, earphones, and the like. Demands for such devices have risen sharply recently. Generally, a small-sized speaker is referred to as a micro speaker or a receiver.

In general, a speaker for reproducing high pitched sounds is referred to as a tweeter. It is difficult to reproduce a high pitched sound having a frequency of 20 kHz or more by using a tweeter using a conventional diaphragm having a dome shape. A leaf tweeter configured by changing a structure of a tweeter has been used to prevent attenuation of a driving force in a high frequency range.

As shown in FIG. 1, a conventional leaf tweeter 10 includes a frame 11, a yoke 12, a permanent magnet 13, a plate 14, and a diaphragm 17 to which a coil 16 is attached. In a magnetic circuit including the yoke 12, the permanent magnet 13, and the plate 14, two magnetic air gaps 15 are formed by an outer circumferential surface of the plate 14 and an inner circumferential surface of the yoke 12. In this case, the diaphragm 17 is disposed such that the coil 16 is disposed on upper surfaces of the air gaps 15. The diaphragm 17 and the magnetic circuit are fixed to each other by the frame 11. In the leaf tweeter 10, when a current flows through the coil 16, a driving force is generated in the coil 16 integrated with the diaphragm 17 to drive the diaphragm 17.

A conventional speaker includes a single perpendicular-magnetized permanent magnet, a plate attached onto the permanent magnet, and a yoke attached to a lower portion of the permanent magnet. Thus, since paramagnetic plates are attached to opposite sides of the permanent magnet, it is difficult to further make the speaker thin.

When a conventional speaker is configured by using a thin magnetic circuit, the speaker may have a low magnetic force and low efficiency.

### SUMMARY OF THE INVENTION

The present invention provides a slim type speaker and a magnetic circuit therefor, wherein a perpendicular-magnetized permanent magnet and a horizontal-magnetized permanent magnet are arranged in the slim type speaker so as to further thin a speaker while increasing a magnetic force.

According to an aspect of the present invention, there is provided a magnetic circuit for a slim type speaker, including a perpendicular-magnetized permanent magnet; a plate that is formed of a paramagnetic material and is attached to a surface of the perpendicular-magnetized permanent magnet; and horizontal-magnetized permanent magnets that are arranged at opposite sides of the perpendicular-magnetized permanent magnet and are spaced apart from the perpendicular-magnetized permanent magnet by a predetermined interval, wherein the perpendicular-magnetized permanent magnet and the horizontal-magnetized permanent magnets interact with each other to form a uniform magnetic field.

The thickness of the horizontal-magnetized permanent magnet may be equal to a total thickness of the perpendicular-magnetized permanent magnet and the plate. The perpendicular-magnetized permanent magnet may have a bar shape and is disposed between the horizontal-magnetized permanent magnets, and the horizontal-magnetized permanent magnets may each have a bar shape, may be arranged at the opposite sides of the perpendicular-magnetized permanent magnet, and may be spaced apart from the perpendicular-magnetized permanent magnet by the predetermined interval to form a magnetic gap. In addition, the perpendicular-magnetized permanent magnet may have a plate shape and may be disposed in a central portion, and the horizontal-magnetized permanent magnet may have a ring shape so as to surround the perpendicular-magnetized permanent magnet.

According to an aspect of the present invention, there is provided a slim type speaker including a bottom case; a magnetic circuit comprising a perpendicular-magnetized permanent magnet and a horizontal-magnetized permanent magnet which are spaced apart from each other by a predetermined interval on the bottom case, and a plate attached to a surface of the perpendicular-magnetized permanent magnet; a diaphragm; a voice coil that is attached on a lower surface of the diaphragm, is disposed in a magnetic gap between the perpendicular-magnetized permanent magnet and the horizontal-magnetized permanent magnet, and vibrates the diaphragm; and a front cover that is coupled to the bottom case to closely fix the magnetic circuit and the diaphragm.

The magnetic circuit may include a perpendicular-magnetized permanent magnet; a plate that is formed of a paramagnetic material and is attached to a surface of the perpendicular-magnetized permanent magnet; and a plurality of horizontal-magnetized permanent magnets each having a bar shape, wherein the perpendicular-magnetized permanent magnet may be disposed between the plurality of horizontal-magnetized permanent magnets that are disposed in parallel to each other such that the plurality of horizontal-magnetized permanent magnets support the diaphragm and interact with the perpendicular-magnetized permanent magnet to form a uniform magnetic field.

The voice coil may be formed by forming a conductive pattern in a coil form on a flexible printed circuit board (FPCB) substrate. A signal may be applied to the voice coil via a feed pattern connected to a feed unit. The feed pattern may be connected to the feed unit through an empty space formed between the perpendicular-magnetized permanent magnet and the horizontal-magnetized permanent magnets.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic diagram of a conventional microspeaker;

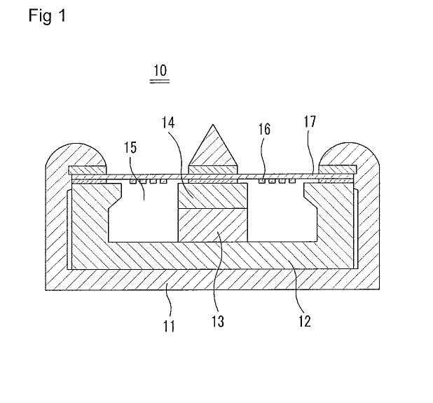

FIG. 2 is an exploded perspective view of a slim type speaker according to an embodiment of the present invention;

FIG. 3 is a lateral cross-sectional view of a slim type speaker according to an embodiment of the present invention;

FIG. 4 is a lateral cross-sectional view of a magnetic circuit of a speaker according to an embodiment of the present invention;

FIG. 5 is a plan view of a magnetic circuit of a speaker according to an embodiment of the present invention; and

FIG. 6 is a set of diagrams for describing a magnetic density of a magnetic circuit according to an embodiment of the present invention.

### DETAILED DESCRIPTION OF THE INVENTION

Hereinafter, one or more embodiments of the present invention will be described in detail with reference to the following examples. However, these examples are not intended to limit the purpose and scope of the one or more embodiments of the present invention.

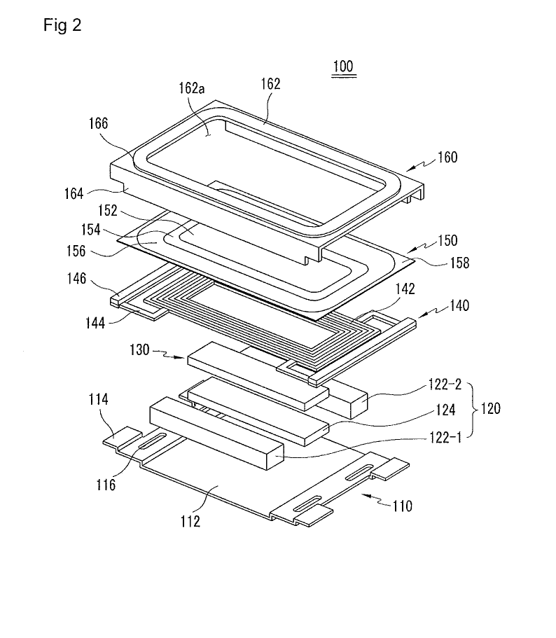

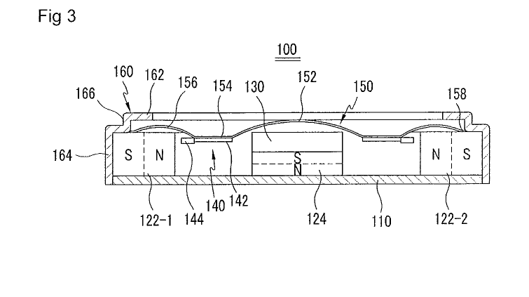

FIG. 2 is an exploded perspective view of a slim type speaker 100 according to an embodiment of the present invention. FIG. 3 is a lateral cross-sectional view of the slim type speaker 100 according to an embodiment of the present invention.

Referring to FIGS. 2 and 3, the slim type speaker 100 includes a bottom case 110 for fixing horizontal-magnetized permanent magnets 122-1 and 122-2 and adjusting an acoustic feature, a magnetic circuit 120 including the two horizontal-magnetized permanent magnets 122-1 and 122-2 each having a bar shape, a single perpendicular-magnetized permanent magnet 124 having a bar shape, and a paramagnetic plate 130 attached to an upper surface of the perpendicular-magnetized permanent magnet 124, a voice coil 140 disposed in a magnetic gap of the magnetic circuit 120 and of a flexible printed circuit board (FPCB) type, a diaphragm 150 that is adhered to the voice coil 140 and generates a sound pressure while vibrating together with the voice coil 140, and a front cover 160 that is coupled to the bottom case 110 to closely fix the magnetic circuit 120 and the diaphragm 150. A wound type coil obtained by winding a coil may be used as the voice coil 140.

Referring to FIGS. 2 and 3, the bottom case 110 and the front cover 160 are coupled to each other to form a housing forming a space where components are installed. According to the present embodiment, the bottom case 110 includes a flat plate 112 formed of a non-magnetic material and having a rectangular shape and includes wings 114 that are formed on opposite later sides so as to support feed units 146 of the voice coil 140 and coupling holes 116 for coupling with the front cover 160.

The front cover 160 includes a hole 162a that is formed in a central portion of an upper portion 162 so as to propagate a sound pressure due to vibration of the diaphragm 150, a lateral wall 164 that is formed on opposite lateral sides so as to be fitted to the bottom case 110, and a step projection 166 for closely fixing an end portion 158 of an edge 156 of the diaphragm 150 to the horizontal-magnetized permanent magnets 122-1 and 122-2.

The magnetic circuit 120 includes the perpendicular-magnetized permanent magnet 124 having a bar shape, the paramagnetic plate 130 attached on the upper surface of the perpendicular-magnetized permanent magnet 124, and the horizontal-magnetized permanent magnets 122-1 and 122-2 each having a bar shape. In addition, the magnetic circuit 120 may be configured such that the perpendicular-magnetized permanent magnet 124 is disposed between the horizontal-magnetized permanent magnets 122-1 and 122-2 that are disposed in parallel to each other on the bottom case 110 so as to function as a frame and may form a uniform magnetic field in conjugation with the perpendicular-magnetized permanent magnet 124. In particular, the magnetic circuit 120 may generate a large magnetic force by increasing the thickness of each of the horizontal-magnetized permanent magnets 122-1 and 122-2. In addition, the perpendicular-magnetized permanent magnet 124 having a small thickness is configured such that a total thickness of the perpendicular-magnetized permanent magnet 124 together with a metallic plate, that is, the paramagnetic plate 130, is equal to the total thickness of the horizontal-magnetized permanent magnets 122-1 and 122-2. As a result, a speaker and receiver having excellent acoustic feature may be manufactured while reducing a thickness of a magnetic circuit.

The voice coil 140 is formed by forming a conductive pattern 142 in a coil form on a FPCB substrate. A signal is applied to the voice coil 140 via a feed pattern 144 connected to the feed unit 146. The feed pattern 144 is connected to the feed unit 146 through an empty space formed between the perpendicular-magnetized permanent magnet 124 and the horizontal-magnetized permanent magnets 122-1 and 122-2. The feed pattern 144 is attached to the diaphragm 150 and is disposed in a magnetic gap formed between the perpendicular-magnetized permanent magnet 124 and the horizontal-magnetized permanent magnets 122-1 and 122-2. Thus, when an electrical signal is applied to the voice coil 140 via the feed unit 146, mechanical energy is generated in conjugation with a magnetic field of the magnetic circuit 120 such that the voice coil 140 moves up and down. Thus, the diaphragm 150 to which the voice coil 140 is attached generates sound while vibrating up and down. The diaphragm 150 is divided by a boundary portion 154 into an internal dome 152 and an external edge 156. An upper end portion of the voice coil 140 is adhered to a lower surface of the boundary portion 154 of the diaphragm 150.

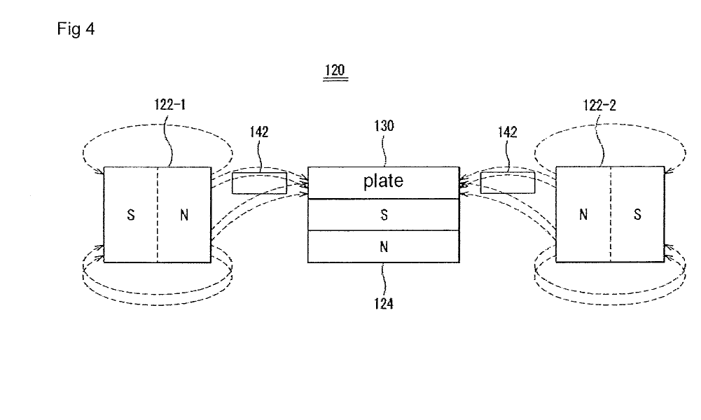

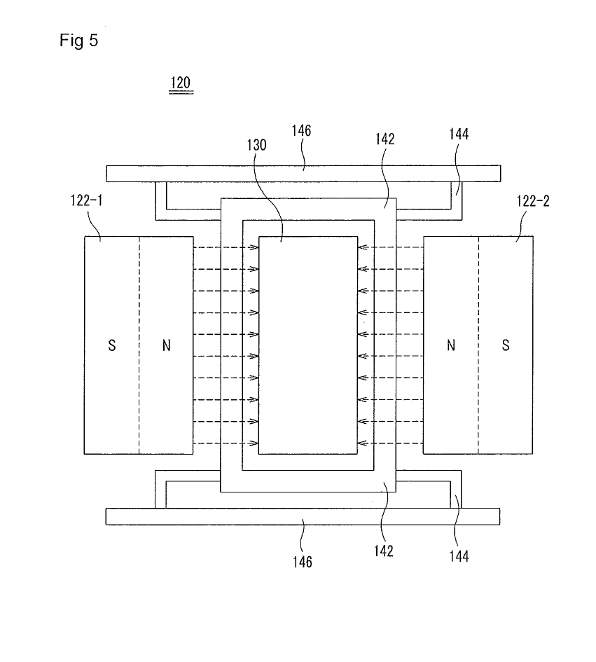

FIG. 4 is a lateral cross-sectional view of a magnetic circuit of a speaker according to an embodiment of the present invention. FIG. 5 is a plan view of a magnetic circuit of a speaker according to an embodiment of the present invention.

Referring to FIGS. 4 and 5, in the magnetic circuit 120, magnetic lines originating from the N poles of the horizontal-magnetized permanent magnets 122-1 and 122-2, which are relatively thick and are disposed at opposite sides of the perpendicular-magnetized permanent magnet 124 disposed therebetween, concentrate on the S pole of the perpendicular-magnetized permanent magnet 124 through a magnetic gap in which a voice coil 140 is positioned. Thus, a large and uniform magnetic flux is formed in the magnetic gap between the perpendicular-magnetized permanent magnet 124 and the horizontal-magnetized permanent magnets 122-1 and 122-2. Accordingly, an interaction force with the voice coil 140 positioned in the magnetic gap may be increased so as to generate high quality sound. In addition, the voice coil 140 is positioned in the magnetic gap and surrounds the paramagnetic plate 130. The feed pattern 144 extends through the magnetic gap formed between the perpendicular-magnetized permanent magnet 124 and the horizontal-magnetized permanent magnets 122-1 and 122-2 such that a current may be fed from the feed unit 146.

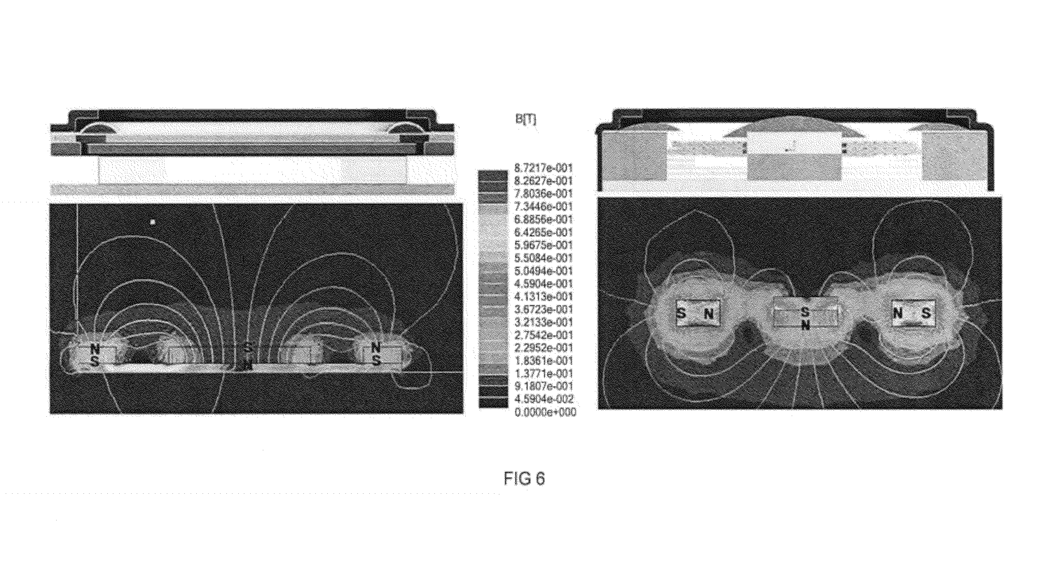

FIG. 6 is a set of comparison diagrams showing a case where three bar-shape permanent magnets 122-1, 122-2, and 124 are perpendicularly magnetized and a case where two permanent magnets 122-1 and 122-2 are horizontally magnetized and only a permanent magnet 124 disposed therebetween is perpendicularly magnetized, in order to describe the properties of a magnetic circuit according to an embodiment of the present invention.

Referring to FIG. 6, when the two permanent magnets 122-1 and 122-2 are horizontally magnetized and only the permanent magnet 124 disposed therebetween is perpendicularly magnetized, the magnetic efficiency of the magnetic circuit may be remarkably increased compared to the case where the three bar-shape permanent magnets 122-1, 122-2, and 124 are perpendicularly magnetized.

According to one or more embodiments of the present invention, a magnetic circuit may form a large and uniform magnetic flux by attaching a paramagnetic metallic plate onto a horizontal-magnetized permanent magnet and a perpendicular-magnetized permanent magnet. In particular, the horizontal-magnetized permanent magnet may have a great thickness to generate a large magnetic force. In addition, the perpendicular-magnetized permanent magnet having a small thickness is configured such that a total thickness of the perpendicular-magnetized permanent magnet together with the metallic plate is equal to the total thickness of the horizontal-magnetized permanent magnets. As a result, a slim type speaker and receiver having excellent acoustic feature may be manufactured while reducing a thickness of the magnetic circuit.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A magnetic circuit for a slim type speaker, comprising:
a perpendicular-magnetized permanent magnet;
a plate that is formed of a paramagnetic material and is attached to a surface of the perpendicular-magnetized permanent magnet; and
horizontal-magnetized permanent magnets that are arranged at opposite sides of the perpendicular-magnetized permanent magnet and are spaced apart from the perpendicular-magnetized permanent magnet by a predetermined interval,
wherein the perpendicular-magnetized permanent magnet and the horizontal-magnetized permanent magnets interact with each other to form a uniform magnetic field.

2. The magnetic circuit of claim 1, wherein a thickness of the horizontal-magnetized permanent magnet is greater than a thickness of the perpendicular-magnetized permanent magnet.

3. The magnetic circuit of claim 2, wherein the thickness of the horizontal-magnetized permanent magnet is equal to a total thickness of the perpendicular-magnetized permanent magnet and the plate.

4. The magnetic circuit of claim 1, wherein the perpendicular-magnetized permanent magnet has a bar shape and is disposed between the horizontal-magnetized permanent magnets, and
wherein the horizontal-magnetized permanent magnets each have a bar shape, are arranged at the opposite sides of the perpendicular-magnetized permanent magnet, and are spaced apart from the perpendicular-magnetized permanent magnet by the predetermined interval to form a magnetic gap.

5. A slim type speaker comprising:
a bottom case;
a magnetic circuit comprising a perpendicular-magnetized permanent magnet and a horizontal-magnetized permanent magnet which are spaced apart from each other by a predetermined interval on the bottom case, and a plate attached to a surface of the perpendicular-magnetized permanent magnet;
a diaphragm;
a voice coil that is attached on a lower surface of the diaphragm, is disposed in a magnetic gap between the perpendicular-magnetized permanent magnet and the horizontal-magnetized permanent magnet, and vibrates the diaphragm; and
a front cover that is coupled to the bottom case to closely fix the magnetic circuit and the diaphragm.

6. The slim type speaker of claim 5, wherein the magnetic circuit comprises a perpendicular-magnetized permanent magnet; a plate that is formed of a paramagnetic material and is attached to a surface of the perpendicular-magnetized permanent magnet; and a plurality of horizontal-magnetized permanent magnets each having a bar shape,
wherein the perpendicular-magnetized permanent magnet is disposed between the plurality of horizontal-magnetized permanent magnets that are disposed in parallel to each other such that the plurality of horizontal-magnetized permanent magnets support the diaphragm and interact with the perpendicular-magnetized permanent magnet to form a uniform magnetic field.

7. The slim type speaker of claim 5, wherein the voice coil is a wound type coil or a flexible printed circuit board (FPCB) type coil.
